(19) United States
(12) Patent Application Publication
(10) Pub. No.: US 2008/0149151 A1
(43) Pub. Date: Jun. 26, 2008

(54) DEVICE FOR CLEANING THE INNER WALLS OF A DUCT CARRYING A FLUID WHICH CONTAINS IMPURITIES

(75) Inventor: Philippe GUICHARD, Chabeuil (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/962,055

(22) Filed: Dec. 20, 2007

(30) Foreign Application Priority Data
Dec. 20, 2006 (FR) 06 11085

(51) Int. Cl. B08B 9/023; B08B 9/00

(52) U.S. Cl. 134/58 R; 134/166 R

(57) ABSTRACT

The invention relates to the cleaning of the inner walls of ducts carrying fluids which contain impurities. The invention is particularly applicable to the air inlet ducts of static pressure probes mounted on aircraft. More specifically, the invention proposes a device for cleaning the inner walls of a principal duct. The principal duct carries a fluid which contains impurities. The impurities are deposited on the inner walls of the principal duct. The fluid has an insufficient flow rate in the principal duct to displace the deposited impurities. The principal duct has an axis running in a direction Z. This cleaning device has a secondary duct placed inside the duct. The secondary duct carries the fluid which contains impurities which are deposited on the inner walls of the secondary duct. The secondary duct is movable with respect to the principal duct. The secondary duct has an axis running in the direction Z. A first displacement device displaces the secondary duct with respect to the principal duct, in the direction Z.

### RELATED APPLICATIONS

The present application is based on, and claims priority from, French Application Number 06 11085, filed Dec. 20, 2006, the disclosure of which is hereby incorporated by reference herein in its entirety.

### FIELD OF THE INVENTION

The invention relates to the cleaning of the inner walls of ducts carrying fluids which contain impurities. The invention is particularly applicable to the air inlet ducts of static pressure probes mounted on aircraft.

### BACKGROUND OF THE INVENTION

When a fluid which contains impurities flows in a duct, some impurities may be deposited on the inner walls of the duct. Over time, the deposited impurities create accumulations of impurities which are fixed to the inner walls and which may perturb the flow of the fluid in the duct because of the modification of its geometry. These deposits of impurities and these formations of accumulations are encountered fairly often when the flow of fluid in the duct is insufficient to displace the deposited impurities. The deposits are caused either by an adhesion of impurities to the inner walls of ducts or by accumulations of impurities due to micro-turbulences in calm zones of the fluid bed.

This situation is particularly troublesome when the flow of fluid in the duct is used for making a measurement, for example in the case of the air inlet ducts of static pressure sensors. These sensors are used to provide a measurement of altitude on board an aircraft, and their correct operation is particularly critical for the control of aircraft. Even a slight modification of the geometry at the inlet of the duct can give rise to errors in the static pressure measurement. If there is a partial obstruction of the air inlet ducts of such a sensor, the response time of the sensor is affected; if the obstruction is total, the static measurement itself is falsified.

There are known devices for eliminating deposits and accumulations of impurities formed on the inner walls of ducts: discharge openings provided in the walls of the duct are a first solution which can be described as “passive”, since gravity, or a flow of fluid through the duct, contributes to the drainage of the impurities towards these discharge openings.

Mechanical scraping of the inner walls of the duct is a second solution for eliminating impurities which partially or totally obstruct the duct.

There are also known devices for cleaning by ultrasound in a liquid bath, and vibratory self-cleaning devices, which are used, for example, in fuel injectors: these devices are based on an identical principle, namely a displacement of the impurities which is achieved by causing the surrounding fluid to vibrate, the vibration being created by electromechanical actuators, generally of the piezoelectric type, positioned on the surface of the wall to be cleaned.

Essentially, discharge openings placed in the duct towards which the impurities can be drained enable certain impurities to be discharged, provided that they are detached from the walls of the duct; however, some impurities adhere tightly to the inner walls and cannot be detached either spontaneously or under the effect of gravity or a weak flow of fluid.

Mechanical scraping comprises the advantage of combining a stage of detaching the impurities and a stage of discharging the impurities, but it comprises the following two drawbacks:

it usually requires the disassembly of the duct, which can be highly disadvantageous especially if it is frequent, which is the case, in particular, with static pressure sensors mounted on aircraft;

the function relating to the fluid flow is not available while the scraping is taking place.

Finally, active cleaning devices require a flow of fluid in the duct, which is not the case in ducts such as air ducts for static pressure sensors.

### SUMMARY OF THE INVENTION

The object of the invention is to overcome these drawbacks. More precisely, the invention proposes a device for cleaning the inner walls of a principal duct, the principal duct carrying a fluid which contains impurities, the impurities being deposited on the inner walls of the principal duct, the fluid having an insufficient flow rate in the principal duct to displace the deposited impurities, the principal duct having an axis running in a direction Z, wherein this device comprises:

a secondary duct placed inside the duct, the secondary duct carrying the fluid which contains impurities which are deposited on the inner walls of the secondary duct, the secondary duct being movable with respect to the principal duct, the secondary duct having an axis running in the direction Z;

a first displacement device which displaces the secondary duct with respect to the principal duct, in the direction Z.

The cleaning device according to the invention comprises the advantage of being adaptable to a geometry of sensors in use, thus facilitating retrofit operations, in other words facilitating the fitting of a cleaning device according to the invention to sensors which are in use.

A second advantage of the device according to the invention is that it is energy-saving: its use requires only a displacement device for displacing the secondary duct with respect to the principal duct.

A third advantage of the device according to the invention is that it is inexpensive and uses a simple technology, namely that of electromechanical actuators (piezoelectric or magneto-electric) which generate a small displacement at low frequency.

A fourth advantage of the device according to the invention, when it is combined with an air inlet duct of a pressure sensor fitted to an aircraft, is that it can operate continuously, even when the static pressure sensor is in operation. This property enables the cleaning device according to the invention to prevent an accumulation of impurities, dust, water or ice while the aircraft is in use.

A fifth advantage of the device according to the invention lies in the combination of the solutions to two complementary problems which it proposes, namely:

the detachment of impurities deposited on the inner walls, by the creation of vibrations which can be at high frequency;

the discharge of the detached impurities from the duct.

A final advantage of the device according to the invention lies in its self-testing capability, which is a highly desired property in the field of on-board aeronautical equipment, since it enables equipment to be replaced very quickly after a fault comprises occurred.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows, in transverse cross section, an air inlet of a sensor of static pressure Ps;

FIG. 2 shows, in transverse cross section, an air inlet of a sensor of static pressure Ps having a cleaning device according to the invention;

FIG. 3 shows, in a perspective view, a first embodiment of a secondary duct of a cleaning device according to the invention;

FIG. 4 shows, in a perspective view, a second embodiment of a secondary duct of a cleaning device according to the invention;

FIG. 5 shows, in a perspective view, a third embodiment of a secondary duct of a cleaning device according to the invention.

### DETAILED DESCRIPTION OF THE INVENTION

Advantageously, the principal duct is an air inlet duct of a static pressure sensor.

The control of any aircraft requires a knowledge of its relative speed with respect to the air, in other words with respect to the relative wind. This speed is determined by means of sensors of static pressure Ps, of total pressure Pt, of the angle of incidence α, and of the sideslip angle β. α and β give the direction of the speed vector in a reference system relating to the aircraft, and (Pt-Ps) gives the modulus of this speed vector.

The different static pressure, total pressure and incidence sensors can be combined in one sensor, called a multi-function sensor. This sensor, for example the sensor described in French Patent FR 2 665 539, does not enable the static pressure Ps to be measured at the point where it is located. This is because the air flow is perturbed by the outer shape of the aircraft. In order to determine the infinite upstream static pressure Ps, it is necessary to use a plurality of sensors, generally two, positioned at precise locations on the skin of the aircraft, for example symmetrically with respect to a vertical plane of symmetry of the aircraft. These two sensors form a measurement channel.

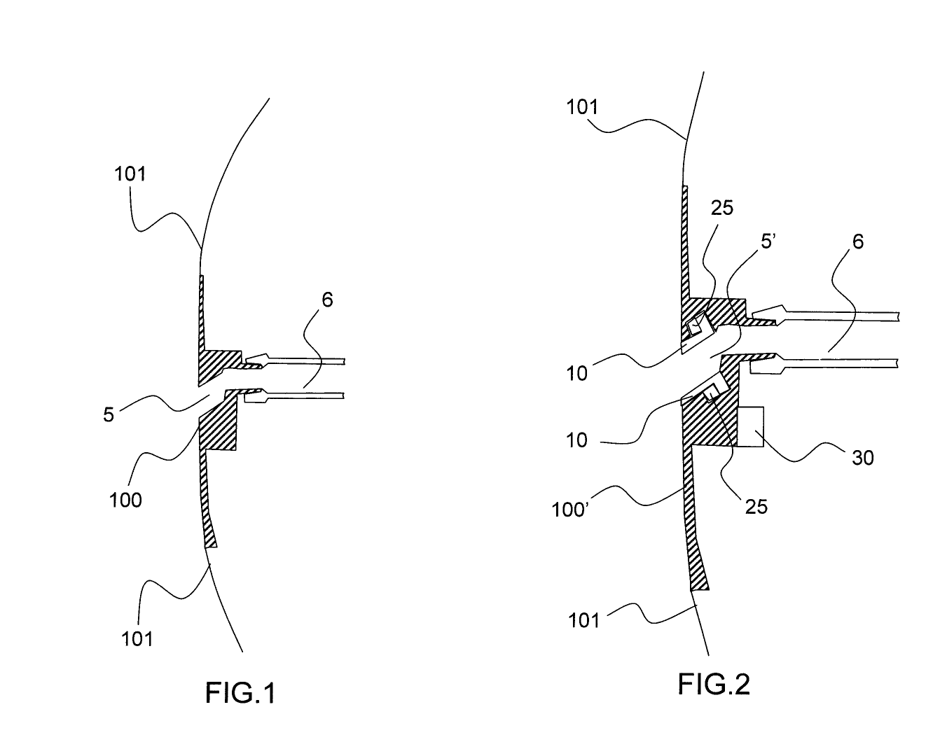

FIG. 1 shows, in transverse cross section, an air inlet of a sensor of static pressure Ps. The purpose of the air inlet of the sensor is to convey to a pressure sensor, not shown in the figure, an air pressure which is not perturbed by the movement of the aircraft. No flow occurs unless the pressure varies.

Conventionally, the air inlet of a static pressure sensor fitted to an aircraft comprises:

a mechanical interface module 100 whose outer surface is an extension of the skin surface of the aircraft 101;

a principal duct 5, inserted into the module 100, the unperturbed air flow being guided between the inner walls 1 of the principal duct 5, which is extended by an auxiliary duct 6 to convey the air to the pressure sensor, the inner walls 1 having dimensions and a shape adapted to create the minimum perturbation of an air flow entering the principal duct 5. The principal duct 5 comprises an axis running in the direction Z.

In general, the axis of the principal duct 5 is orientated so as to promote the discharge of impurities which may become attached to its inner walls 1. For example, if the principal duct 5 is cylindrical, the cylinder comprises an axis running towards a lower part of the aircraft. However, the orientation of the principal duct is not sufficient to discharge all the impurities which may be deposited on the inner walls 1 of the principal duct 5.

FIG. 2 shows, in transverse cross section, an air inlet of a sensor of static pressure Ps having a cleaning device according to the invention. The pressure sensor is fitted, for example, to the same aircraft as that indicated in FIG. 1. In this case, the air inlet of a static pressure sensor comprises:

a mechanical interface module 100′ whose outer surface is an extension of the skin surface of the aircraft, 101;

a principal duct 5′, inserted into the module 100′. The principal duct 10′ comprises an axis running in a direction Z;

the cleaning device according to the invention, which is housed in the principal duct 10′.

The cleaning device according to the invention comprises:

a secondary duct 10, which comprises an external shape enabling it to be housed in the principal duct 5′, and an internal shape similar to that of the inner walls of a principal duct 5′ according to the prior art. The secondary duct 10 is movable with respect to the principal duct 5′, and the secondary duct 10 comprises an axis identical to that of the principal duct 5′. The secondary duct 10 is extended by an auxiliary duct 6 to convey the air to the pressure sensor.

a main displacement device 20, which displaces the secondary duct 10 with respect to the principal duct 5′, in the direction Z.

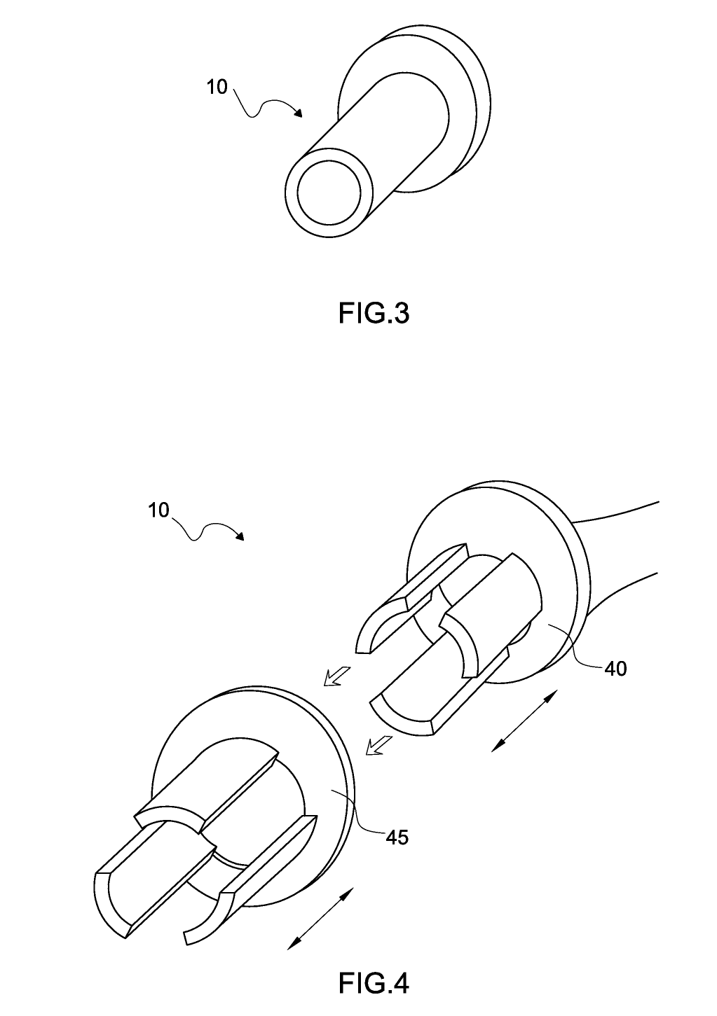

A first embodiment of a secondary duct 10 is shown in FIG. 3. In this first embodiment, the secondary duct 10 is made in one piece, and its inner walls are substantially cylindrical.

The displacement of the secondary duct 10 caused by the principal displacement device 20 gives rise to what is called the “vibratory feeder” phenomenon, in which a rigid support is made to vibrate, thus causing a unidirectional movement, in a succession of jumps, of objects placed on this support. This phenomenon is used at present to convey and sort small objects.

According to the invention, the overall movement of the secondary duct 10 is temporally asymmetric and temporally periodic; for example, the movement is a sequence of two movements, namely translation in a “forward” direction followed by translation in a “return” direction, the translation in the “return” direction having a shorter duration than that of the translation in the “forward” direction.

The temporal asymmetry of the overall movement causes the objects, in this case the impurities deposited on the inner walls of the secondary duct 10, to have a limit of adhesion which is overcome more rapidly in one translational movement than in the other: during the translational movement in the “forward” direction, the impurity follows the movement of the secondary duct 10, while during the translational movement in the “return” direction the impurity slides on the inner walls of the secondary duct 10, and is displaced with respect to the duct by a jumping movement. Successive jumps cause a pseudo-continuous displacement of the impurities in the direction of the translation and in the direction of the translational movement in the “forward” direction.

Advantageously, the first displacement device displaces the secondary duct 10, in an overall movement which is temporally periodic and temporally asymmetric.

Advantageously, the principal displacement device 10 comprises:

an actuator 25, which bears on the principal duct 5′, and which is fixed to the secondary duct 10, the actuator 25 displacing the secondary duct 10 with respect to the principal duct 5′, according to a displacement command;

a control device 30, delivering the displacement command to the actuator 25.

Advantageously, the control device 30 delivers to the actuator 25 a displacement command having a “sawtooth” form with respect to time.

For example, the displacement command causes an overall displacement of 0.1 millimetre at a frequency of 1 kilohertz with an asymmetry factor of 10%; in other words, the duration of the “forward” translational movement is equal to 9 times the duration of the “return” translational movement.

Advantageously, the control device 30 delivers to the actuator 25 a displacement command having a frequency of less than 100 kilohertz.

Advantageously, the principal displacement device 20 is an electromechanical component.

In particular, piezoelectric devices can be self-tested by measurement of their impedance.

Advantageously, the principal displacement device 20 is an electromagnetic component.

Advantageously, the principal duct 5 and the secondary duct 20 have inner walls 1, 9 which form cylinders.

The overall movement of the secondary duct 10 comprises the principal function of contributing to the discharge of the impurities deposited on the inner walls 9 of the secondary duct 10 towards one of the ends of the secondary duct 10. However, not all the impurities deposited on the inner walls 9 are detached by the overall movement of the secondary duct 10: a complementary movement of the secondary duct 10 must be provided, to detach deposits which have formed on the surface of its inner walls.

The overall movement can be combined with a complementary movement which is periodic and asymmetric with a frequency greater than that of the overall movement, in order to detach these impurities. This combination can be created, for example, by arranging for the delivery to the actuator 25 of a displacement command which includes a sum of the principal displacement command described above and a complementary displacement command which is periodic, asymmetric and at a high frequency, of about 500 kilohertz for example.

However, it may be difficult to detach particularly adhesive and bulky deposits, such as deposits produced by insects, which have formed between two uses of the device according to the invention, owing to the resistance to detachment of these deposits.

There are existing methods for resolving this specific problem: these consist in the provision of a shear movement between the parts of the inner walls of the secondary duct 10 positioned in a “comb” configuration, being interleaved with each other and movable with respect to each other. The aim of this method is to dislodge the impurities which have adhered to this inner wall.

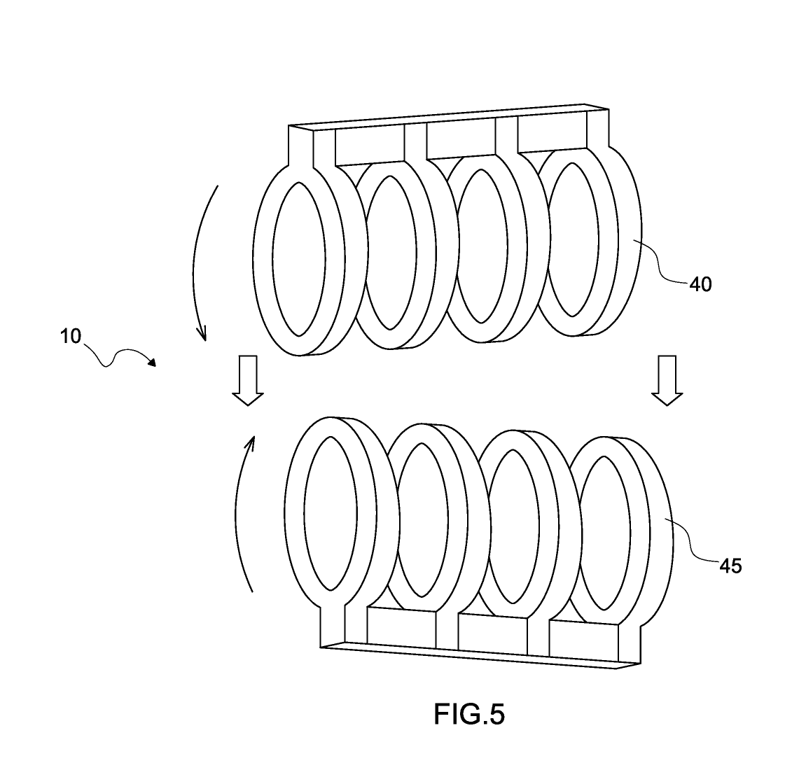

These alternative solutions take the form of specific embodiments of the secondary duct 10 which are illustrated in FIGS. 4 and 5.

Advantageously, the secondary duct comprises:

at least two interacting structures 40, 45, which are movable with respect to each other;

a secondary displacement device which carries out a relative displacement of an interactive structure 40, 45 with respect to the other at a frequency F.

FIG. 4 shows a second embodiment of the secondary duct of a cleaning device according to the invention permitting a shear movement in the direction Z of the secondary duct 10.

Advantageously, the secondary duct 10 comprises a first structure 40 and a second structure 45, each of which comprises slots, the slots of the first structure 40 interacting with the slots of the second structure 45, and the displacement of the structures 40, 45 follows the direction Z.

Advantageously, the secondary displacement device displaces the first structure 40 and the second structure 45 with periodic individual movements at a frequency F0, the individual movements being phase shifted by π radians with respect to each other.

Advantageously, the secondary displacement device displaces the first structure 40 and the second structure 45 with two periodic individual movements at the frequencies F1 and F2 respectively.

Advantageously, the secondary displacement device is an electromechanical component.

Advantageously, the secondary displacement device is an electromagnetic component.

FIG. 5 shows a third embodiment of the secondary duct of a cleaning device according to the invention: this is the preferred embodiment.

Advantageously, the secondary duct comprises a first structure 40 and a second structure 45, each of which comprises rings, the rings of the first structure 40 interacting with the rings of the second structure 45, and the displacement of the interacting structures 40, 45 is in a plane perpendicular to the direction Z.

In this third embodiment of the secondary duct, the relative movement of the two structures takes place in a plane perpendicular to the direction of flow of the fluid; this is the preferred embodiment of the secondary duct.

Advantageously, the fluid flowing in the secondary duct is air.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

1. A device for cleaning the inner walls of a principal duct, the principal duct carrying a fluid which contains impurities, the impurities being deposited on the inner walls of the principal duct, the fluid having an insufficient flow rate in the principal duct to displace the deposited impurities, the principal duct having an axis running in a direction Z, wherein the device comprises:
a secondary duct placed inside the principal duct, the secondary duct carrying the fluid which contains impurities which are deposited on the inner walls of the secondary duct, the secondary duct being movable with respect to the principal duct, the secondary duct having an axis running in the direction Z, and a main displacement device, which displaces the secondary duct with respect to the principal duct, in the direction Z.

2. The cleaning device according to claim 1, wherein the principal displacement device displaces the secondary duct in an overall movement which is temporally periodic and temporally asymmetric.

3. The cleaning device according to claims 1, wherein the principal duct is an air inlet duct of a static pressure sensor.

4. The cleaning device according to claims 1, wherein the principal displacement device comprises: an actuator which bears on the principal duct and which is fixed to the secondary duct, the actuator displacing the secondary duct with respect to the principal duct, according to a principal displacement command and a control device delivering the displacement command to the actuator.

5. The cleaning device according to claim 4, wherein the control device delivers to the actuator a principal displacement command which comprises a “sawtooth” temporal form.

6. The cleaning device according to claim 5, wherein the control device delivers to the actuator a principal displacement command which comprises a frequency of less than 100 kilohertz.

7. The cleaning device according to claim 1, wherein the inner walls of the principal duct and of the secondary duct form cylinders.

8. The cleaning device according to claim 1, wherein the secondary duct comprises: at least two interacting structures, which are movable with respect to each other and a secondary displacement device which creates a relative movement of one of two interacting structures with respect to the other, at a frequency F.

9. The cleaning device according to claim 1, wherein the secondary duct comprises a first structure and a second structure, each of which comprises slots, the slots of the first structure interacting with the slots of the second structure, and wherein the displacement of the interacting structures follows the direction Z.

10. The cleaning device according to claim 8, wherein the secondary duct comprises a first structure and a second structure, each of which comprises slots, the slots of the first structure interacting with the slots of the second structure, and wherein the displacement of the interacting structures is in a plane perpendicular to the direction Z.

11. The cleaning device according to of claim 1, wherein the secondary displacement device displaces the first structure and the second structure in individual periodic movements at a frequency F0, the individual movements being phase shifted by π radians with respect to each other.

12. The cleaning device according to of claim 8, wherein the secondary displacement device displaces the first structure and the second structure in two individual periodic movements at the frequencies F1 and F2 respectively.

13. The cleaning device according to claim 1, wherein the principal displacement device is an electromechanical component.

14. The cleaning device according to claim 2, wherein the principal displacement device is an electromagnetic component.

15. The cleaning device according to claim 3, wherein the secondary displacement device is an electromechanical component.

16. The cleaning device according to claim 4, wherein the secondary displacement device is an electromagnetic component.

17. The cleaning device according to claim 5, wherein the fluid flowing in the secondary duct is air.
